(19) United States
(12) Patent Application Publication
(10) Pub. No.: US 2017/0293481 A1
(43) Pub. Date: Oct. 12, 2017

(54) Updating Software Packets in Water Installation Controlling Apparatus

(71) Applicant: FLUIDRA, S.A., Sabadell (ES)

(72) Inventors: David GIMÉNEZ PALLARÈS, Sabadell (ES); Òscar PENELO ARIAS, Viladecavalls (ES); Domènec MELENDO CASADO, Viladecavalls (ES); Daniel BUJALANCE COLL, Viladecavalls (ES)

(21) Appl. No.: 15/630,551

(22) Filed: Jun. 22, 2017

Related U.S. Application Data
(63) Continuation of application No. PCT/EP2014/079283, filed on Dec. 23, 2014.

(51) Int. Cl. G06F 9/445

(52) U.S. Cl. CPC G06F 8/65

(57) ABSTRACT

A method of updating software packets in a water installation controlling apparatus, the method comprising obtaining data comprising a reference of a last version of the software packets; for each software packet, comparing the obtained reference with a reference of the current version used in the water installation controlling apparatus; if the obtained reference of the last version does not coincide with the reference of the current version, selecting a corresponding software packet to be updated; in case at least one corresponding software packet is to be updated, requesting to the updating system a time when the update must be performed; receiving from the updating system the requested time; for each software packet to be updated at the time for performing the update, downloading the last version; replacing the software of the current version by the software comprised in the downloaded last version.

### CROSS REFERENCE TO RELATED APPLICATIONS

This application relates to and claims the benefit and priority to International Application No. PCT/EP2014/079283, filed Dec. 23, 2014.

### FIELD OF THE INVENTION

The present disclosure relates to software packets updates and more specifically to methods, systems and computer program products for updating one or more software packets in water installation controlling apparatus.

### BACKGROUND

Water installations, such as swimming pools, artificial spas, fish farms or the like require that a number of their parameters is controlled at any given time. For example, in case of swimming pools, the temperature, the quality, or the quantity of water needs to be monitored and controlled as well as, e.g. the lighting of the pool (internal lighting) or its surrounding. Typically, these parameters are controlled, through water installation controlling apparatus, by separate control devices (or water installation devices) that are arranged with the water installation. Example control devices are thermostats, pumps, water purification equipment etc.

Basically, a water installation controlling apparatus can be defined as an apparatus configured to operate water installation devices through which said apparatus may control different parameters of a water installation.

To perform this control different types of software in the water installation controlling apparatus are required. For example, an operating system, controlling software running on the operating system and software for the water installation controlling apparatus operating the water installation devices are required.

Due to the presence of said software in the water installation controlling apparatus, an updating management is needed in the form of a process based on a strategy for selecting the software to be updated with a new release. Basically, this updating management is important for fixing security vulnerabilities and other bugs, and improving the usability and/or performance of the software.

However, at the present time, some known water installation controlling apparatus cannot update their software from the Internet because most of them are not connected with the Internet or do not have mechanisms implemented to do so.

In other known water installation controlling apparatus, a relatively strong relation exists between the hardware and software, so that a change in the software can involve a change in the hardware. In some cases, the hardware/software manufacturer tends to recommend the substitution of the hardware with new software already installed instead of updating the software.

Other water installation controlling apparatus are known in which the software update requires the intervention of an operator, who may not always have the necessary computer skills to perform this task, especially if the operator is a home user. In this case, the user may require a computer expert to carry out this task, which may imply an economic cost and the impossibility of using the water installation controlling apparatus while the computer expert has not updated the software. This situation can also arise in a business environment, if the software update is very specialized and the company does not have adequate staff to do so.

Moreover, in the case of automatic or forced software updates, the software updates can be scheduled regardless of the status of the software update server from which the software updates will be performed. This situation can cause an excessive slowness in the software updates if the server is overloaded with a large number of updates, and, in some cases, an impossibility of updating the software can result if not enough server resources are available.

Consequently, there is a need for a platform that at least partially solves the aforementioned problems.

### SUMMARY OF THE DISCLOSURE

In a first aspect, a method of updating one or more software packets in a water installation controlling apparatus is disclosed. The method may comprise:
obtaining from an updating system data comprising at least a reference of a last version of the one or more software packets;
for each software packet, comparing the obtained reference of the last version of the software packet with the reference of a current version of the corresponding software packet used in the water installation controlling apparatus;
for each software packet, if the obtained reference of the last version of the software packet does not coincide with the reference of the current version of the corresponding software packet, then selecting a corresponding software packet to be updated;

in case at least one corresponding software packet is to be updated,
requesting the updating system to provide a time of when the update must be performed;
receiving from the updating system the requested time taking into account if the update is critical or not;

for each software packet to be updated at the time for performing the update,
downloading the last version of the software packet from the updating system;
replacing the current version of the software packet used in the water installation controlling apparatus by the downloaded last version of the software packet.

This way, updates of software used in the water installation controlling apparatus are performed without requiring to change hardware or the intervention of a user or expert.

The provision of the step relating to requesting the updating system to provide a time of when the update must be performed allows improving the software updates because it is the updating system which performs the scheduling of the software updates and not the water installation controlling apparatus which may not know the load of updates of the updating system. Therefore, the software updates may be rationally scheduled by the updating system avoiding excessive slowness in the software updates (the updating system is not overloaded with a large number of updates).

On other hand, it is possible to request the updating system to provide a time of when the update of each software packet to be updated must be performed or a time of when the update of all software packets to be updated must be performed.

In some examples, the method may comprise requesting the updating system to provide data comprising at least a reference of the last version of the one or more software packets. This way, the data may be automatically sent by the updating system to the water installation controlling apparatus (for example at any given time) or may be automatically requested by the water installation controlling apparatus to the updating system (for example at any given time). In any case, the involvement of a user is not required but it may be possible for a user to force the request of data to the updating system at any time, either from the water installation controlling apparatus itself or from a remote device such as a smartphone or a tablet.

In some examples, the method, in case at least one corresponding software packet is to be updated, may further comprise requesting a user to provide the authorization for performing the update. It is an object of the method to automatically update software packets used in the water installation controlling apparatus without requiring the intervention of a user. Nevertheless, requiring the authorization from a user for updating the software packets may be possible in order for the user to accept or not said update according to his requirements (for example, the user may be doing a specific task with the water installation controlling apparatus and the user may not be interested that the water installation controlling apparatus turns off). This authorization request may be done at any step of the method before replacing the current version of the software packet by the downloaded last version of the software packet. On the other hand, if the user does not respond to the request of the authorization after a given time, by default the system may understand that the update of software packets must be performed.

In some examples, the method may comprise communicating to a user the time when the update must be performed. Said communication may be performed, for example, by means of an electronic message (for example an SMS or an email) either from the water installation controlling apparatus or from another external apparatus. In the last case, the water installation controlling apparatus may communicate to the external apparatus that an electronic message has to be sent to a corresponding user. Thus the water installation controlling apparatus may send to the external apparatus different parameters such as the content of the message and the identifier of the user (for example the phone number or the email address respectively) to which the message has to be sent.

In some examples, the method may comprise validating the downloaded last version of the software packet. More specifically, in some examples, the obtained data comprising at least a reference of the last version of the one or more software packets may comprise an electronic fingerprint associated to each software packet of the one or more software packets and wherein:

validating the downloaded last version of the software packet may comprise:
obtaining the electronic fingerprint of the last version of the software packet from the obtained data;
generating an electronic fingerprint of the downloaded last version of the software packet;
comparing the obtained electronic fingerprint of the last version of the software packet and the generated electronic fingerprint of the downloaded last version of the software packet;
If the obtained electronic fingerprint of the last version of the software packet does not coincide with the generated electronic fingerprint of the downloaded last version of the software packet:
   downloading again the last version of the software packet from the updating system.

This way, by validating the downloaded last version of the software packet it is possible to verify if said downloaded last version of the software packet corresponds to the last version of the software packet previously cited by the updating system in the data comprising at least a reference of the last version of the one or more software packets. Basically, the electronic fingerprint of the last version of the software packet and the electronic fingerprint of the downloaded last version of the software packet need to be the same. Thus, an error during the download of the last version of the software packet may be detected.

In some examples, the electronic fingerprint may comprise a cryptographic hash value. Then, generating an electronic fingerprint of the downloaded last version of the software packet may comprise applying a cryptographic hash function to the downloaded last version of the software packet. Basically, a cryptographic hash function is a deterministic procedure that takes an arbitrary block of data (in this case the downloaded last version of the software packet) and returns a fixed-size bit string, the (cryptographic) hash value, such that an accidental (e.g. an error in the download) or intentional (e.g. the reference of the last version of the software packet comprised in the obtained data corresponds to an old reference because before the downloading a new version of the software packet had been generated) change to the data will change the hash value. The data to be encoded (i.e. inputted to the hash function) is often called the “message” and the hash value (i.e. the output of the hash function applied to the “message”) is normally called message digest or simply digest.

A hash function that may be used is the SHA-256 (a universal cryptography algorithm from the United States National Security Agency (NSA/CSS)) that belongs to the standard SHA-2 cryptographic hash functions set, although another hash function may be used if e.g. it is demonstrated in the future that SHA-256 is not secure enough. For example, SHA-1 and MD5 where initially considered in the context of these examples, but they were finally discarded due to some reported security flaws.

The security of a hash function is determined by its resistance to collisions. A hash function is collision resistant if its application to different messages (data to be encoded) produces a different message digest. Even though SHA-256 is currently used in the context of these examples (the probability of collision for said hash function is approximately 1 to 10¹⁵ whereas the probability that a given file will generate two different hash codes is zero), it could be substituted in the future by another hash function with improved resistance to collisions (i.e. more secure), such as e.g. SHA-3, which is a new hash standard currently under development.

In some examples, the obtained data comprising at least a reference of the last version of the one or more software packets may further comprise a link to the last version of each software packet of the one or more software packets and downloading the last version of the software packet from the updating system may comprise:
obtaining the link to the last version of the software packet from the obtained data;
initiating a transfer, based on the obtained link, of the last version of the software packet from the updating system;
receiving the last version of the software packet from the updating system.

This link may be secured, for example, by means of a user/password or by means an encryption. The main object in this case is to secure the communication.

In some examples, the obtained data comprising at least a reference of the last version of the one or more software packets may further comprise a parameter indicating if the update of each software packet of the one or more software packets is critical or not. Therefore, whether an update of a software packet is critical or not it is decided by the updating system and not by the water installation controlling apparatus.

In some examples, the method may comprise communicating to a user a completion of the replacement of the current version of the software packet used in the water installation controlling apparatus by the downloaded last version of the software packet. Said communication may be performed, for example, by means of an electronic message (for example a SMS or an email) either from the water installation controlling apparatus or from another external apparatus. In the last case, the water installation controlling apparatus may communicate to the external apparatus that an electronic message has to be sent to a corresponding user. Thus, the water installation controlling apparatus may send to the external apparatus different parameters such as the content of the message (i.e. the completion of the replacement of the software) and the identifier of the user (for example the phone number or the email address respectively) to which the message has to be sent. Obviously, another tasks or actions produced by the execution of the method may be communicated to a user.

In some examples, the method may further comprise storing in a repository data relating to the completion of the replacement of the current version of the software packet used in the water installation controlling apparatus by the downloaded last version of the software packet but another information may be also stored in said repository or in another repository. Said information may be for example data about the beginning and/or the end of the download of the last version of the software packet, the data comprising at least a reference of the last version of the one or more software packets, etc., that is, any success or data produced during the execution of the method may be stored in a repository.

On the other hand, it is important to highlight that this repository may be stored in the water installation controlling apparatus itself or in an external apparatus, which may be connected to the water installation controlling apparatus through a communication network, for example a global communication network such as the Internet.

In some examples, the data comprising at least a reference of the last version of the one or more software packets may be comprised in a file, for example an eXtensible Markup Language (XML) file. The XML language is a markup language that defines a set of rules for encoding documents in a format that is both human-readable and machine-readable.

According to some examples, in case an error is detected during replacing the current version of the software packet used in the water installation controlling apparatus by the downloaded last version of the software packet, the method may comprise replacing the downloaded last version of the software packet by the previous version of the software packet used in the water installation controlling apparatus. Therefore, the downloaded last version of the software packet that was being applied on the water installation controlling apparatus may be replaced by the previous version of the software packet used in the water installation controlling apparatus, that is, by the one which was the current version of the software packet before being replaced by the downloaded last version of the software packet. Furthermore, if it is not possible this option, the water installation controlling apparatus may return to its factory settings.

In some examples, the water installation controlling apparatus may be configured to operate a plurality of water installation device types through software associated to each water installation device type.

Furthermore, a first software packet of the one or more software packets described above may comprise the software associated to each water installation device type that can be operated by the water installation controlling apparatus.

The term “software associated to a water installation device type” comprised in the first software packet may be understood as a descriptor file associated to a water installation device type. Thus, in the context of the present disclosure, a descriptor file for a water installation device may be defined as a piece of software based on a code (i.e. instructions) written under a textual data format, i.e. a human-readable and machine readable format. This piece of software may be seen as a descriptor of (i.e. as describing) how the device has to be operated by a (water installation) controlling apparatus and configured by a user (of the water installation). The water installation controlling apparatus may have a processor configured to execute general purpose software and to process the descriptor file in such a way that the device is operated (by the controlling apparatus) and configured (by a user) in the context of said software of more general purpose. This software of more general purpose may comprise e.g. calls to an interpreter dedicated to interpret and execute the content of the descriptor file. This way, the execution of the general purpose software may cause operation of the device when required by performing necessary functions that are implemented in the descriptor file in a manner which is exclusive for the device. This “exclusive” implementation may depend on e.g. the hardware configuration of the device and other particularities.

At this point it is important to highlight that the first software packet may comprise the software associated to each water installation device type that may be operated by the water installation controlling apparatus and not only the software associated to the water installation devices connected to the water installation controlling apparatus. This way, unlike the known water installation controlling apparatus that often have limited backwards compatibility (they can only control water installation devices that existed before them), the water installation controlling apparatus according to some examples also supports forwards compatibility, that is, it has the ability to adapt to new water installation devices that will be developed in the future. Consequently, when a new water installation device is connected to the water installation controlling apparatus, the later will be capable to operate the new water installation device because it will have available the corresponding software associated to this water installation device type.

In summary, according to these examples, the water installation controlling apparatus may present:
backward compatibility, that is, it may support water installation devices that existed before them;
forward compatibility, that is, it may support water installation devices that may be developed in the future.

In some examples, a second software packet of the one or more software packets may comprise software associated to the water installation controlling apparatus, said software associated to the water installation controlling apparatus being configured for operating at least one water installation device connected to the water installation controlling apparatus, said at least one water installation device belonging to the water installation device types supported by the water installation controlling apparatus.

Basically, the second software packet may comprise software comprising at least one computer program running on the operating system of the water installation controlling apparatus. Said computer program may be capable of operating the water installation devices connected to the water installation controlling apparatus by means of the software associated to each water installation device (that is, the software comprised in the first software packet) for controlling different parameters (e.g. the temperature, the quality, or the quantity of water) of a water installation (e.g. swimming pools, artificial spas, fish farms or the like).

In another aspect, a computer program product is disclosed. The computer program product may comprise program instructions for causing a computing system to perform a method of updating one or more software packets in a water installation controlling apparatus according to some examples disclosed herein. Said computing system may be a part of the water installation controlling apparatus (i.e. a system inside the water installation controlling apparatus configured to reproduce the method described above) of may be the water installation controlling apparatus itself.

The computer program product may be embodied on a storage medium (for example, a CD-ROM, a DVD, a USB drive, on a computer memory or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the method. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program is embodied in a signal that may be conveyed directly by a cable or other device or means, the carrier may be constituted by such cable or other device or means.

Alternatively, the carrier may be an integrated circuit in which the computer program is embedded, the integrated circuit being adapted for performing, or for use in the performance of, the relevant methods.

In yet another aspect, a system for updating one or more software packets in a water installation controlling apparatus is disclosed. The system may comprise computing/electronic means for obtaining from an updating system data comprising at least a reference of a last version of the one or more software packets; computing/electronic means for comparing the obtained reference of the last version of each software packet with a reference of a current version of the corresponding software packet used in the water installation controlling apparatus; computing/electronic means for selecting the corresponding software packet to be updated; computing/electronic means for requesting the updating system to provide a time of when the update must be performed; computing/electronic means for receiving from the updating system the requested time taking into account if the update is critical or not; computing/electronic means for downloading the last version of the software packet from the updating system; computing/electronic means for replacing the current version of the software packet used in the water installation controlling apparatus by the downloaded last version of the software packet.

Basically, this system must be able to reproduce the method described above through electronic/computing means. Said electronic/computing means may be used interchangeably, that is, a part of the described means may be electronic means and the other part may be computer means, or all described means may be electronic means or all described means may be computer means. Examples of a system comprising only electronic means may be a CPLD, an FPGA or an ASIC.

It is important to highlight that said system may be a part of the water installation controlling apparatus (i.e. a system inside the water installation controlling apparatus configured to reproduce the method described above) of may be the water installation controlling apparatus itself.

On the other hand, the information exchange between the system and the updating system may be performed through a communication network, for example a global communication network such as the Internet. Said communication between the system and the updating system may be secured by means of, for example, cryptographic keys and/or a SSL tunnel established between the system and the updating system.

In another aspect, a computing system is disclosed. The computing system may comprise a memory and a processor, embodying instructions stored in the memory and executable by the processor, the instructions comprising functionality to execute a method of updating one or more software packets in a water installation controlling apparatus according to some examples disclosed herein.

Therefore, said computing system must be able to reproduce the method described above by means of instructions executed by the processor. Furthermore, said computing system may be a part of the water installation controlling apparatus (i.e. a computing system inside the water installation controlling apparatus configured to reproduce the method described above) of may be the water installation controlling apparatus itself.

The information exchange between said computing system and the updating system may be performed through a communication network, for example a global communication network such as the Internet. Said communication between the system and the updating system may be secured by means of, for example, cryptographic keys and/or a SSL tunnel established between the computing system and the updating system.

In yet another aspect, a method of operating at least one water installation device connected to a water installation controlling apparatus is disclosed. The water installation controlling apparatus may be configured to operate a plurality of water installation device types by means of a software associated to each water installation device type, said at least one water installation device belonging to the plurality of water installation device types. The method may comprise:
obtaining from the water installation device at least a manufacturer ID and a firmware version of the water installation device;
executing a method of updating one or more software packets in the water installation controlling apparatus according to some examples disclosed herein;
using the corresponding software associated to the water installation device type for operating the water installation device, said corresponding software being selected taking into account the obtained manufacturer ID and the firmware version.

At this point it is important to highlight that the steps of this method may be performed in any order. Thus, for example, the step of executing a method of updating one or more software packets in the water installation controlling apparatus (that is, the update of any software used in the water installation controlling apparatus) may be performed at any time during the execution of the method.

For operating the water installation device it is required to determine the water installation device type to which said device belongs through at least the manufacturer ID and the firmware version. Once the device type is determined, the software associated to the water installation device type to be operated by the water installation controlling apparatus must be obtained.

In some examples, the method may comprise:
obtaining from the water installation device at least the manufacturer ID, the firmware version and a product ID of the water installation device;
using the corresponding software associated to the water installation device type for operating the water installation device, said corresponding software being selected taking into account the obtained manufacturer ID, the firmware version and the product ID of the water installation device.

In this case, for determining the water installation device type not only the manufacturer ID and the firmware version are required but also the product ID of the water installation device.

In some examples, the method may further comprise detecting a new water installation device connected to the water installation controlling apparatus. According to some examples of the method, when a new water installation device is connected to the water installation controlling apparatus, it should determine the water installation device type. For this reason, it is required to obtain at least the manufacturer ID and the firmware version (and probably the product ID) from the new connected water installation device. Then, the corresponding software associated to this water installation device type must be used by the water installation controlling apparatus for operating the new water installation device.

On the other hand, as described above, due to the fact that the first software packet may also comprise the software associated to each water installation device type that can be operated by the water installation controlling apparatus and not only the software associated to the water installation devices connected to the water installation controlling apparatus, the water installation controlling apparatus may immediately operate the new detected water installation device without the intervention of a user or expert.

In another aspect, a computer program product is disclosed. The computer program product may comprise program instructions for causing a computing system to perform a method of operating at least one water installation device connected to a water installation controlling apparatus according to some examples disclosed herein. Said computing system may be a part of the water installation controlling apparatus (i.e. a computing system inside the water installation controlling apparatus configured to reproduce the method described above) of may be the water installation controlling apparatus itself.

In yet another aspect, a system for operating at least one water installation device connected to a water installation controlling apparatus is disclosed. The water installation controlling apparatus may be configured to operate a plurality of water installation device types by means of a software associated to each water installation device type, said at least one water installation device belonging to the plurality of water installation device types. The system may comprise computing/electronic means for obtaining from the water installation device at least a manufacturer ID and a firmware version of the water installation device; a system for updating one or more software packets in a water installation controlling apparatus according to some examples disclosed herein; computing/electronic means for using the corresponding software associated to the water installation device for operating the water installation device, said corresponding software being selected taking into account the obtained manufacturer ID and the firmware version.

Basically, this system must be able to reproduce the method described above by means of electronic/computing means. Said electronic/computing means may be used interchangeably, that is, a part of the described means may be electronic means and the other part may be computer means, or all described means may be electronic means or all described means may be computer means. Examples of a system comprising only electronic means may be a CPLD, an FPGA or an ASIC.

It is important to highlight that said system may be a part of the water installation controlling apparatus (i.e. a system inside the water installation controlling apparatus configured to reproduce the method described above) or may be the water installation controlling apparatus itself.

In another aspect, a computing system is disclosed. The computing system may comprise a memory and a processor, embodying instructions stored in the memory and executable by the processor, the instructions comprising functionality to execute a method of operating at least one water installation device connected to a water installation controlling apparatus according to some examples disclosed herein.

Therefore, said computing system must be able to reproduce the method described above by means of instructions executed by the processor. Furthermore, said computing system may be a part of the water installation controlling apparatus (i.e. a computing system inside the water installation controlling apparatus configured to reproduce the method described above) of may be the water installation controlling apparatus itself.

In yet another aspect, a method of providing updates of one or more software packets to a water installation controlling apparatus is disclosed. The method may comprise:
providing data comprising at least a reference of a last version of the one or more software packets to a water installation controlling apparatus;
receiving a request from the water installation controlling apparatus relating to a time when the update of the software packets to be updated must be performed;
providing the requested time taking into account if the update is critical or not;

for each software packet to be updated at the time for performing the update,
receiving from the water installation controlling apparatus a request for downloading the last version of the software packet;
transmitting the last version of the software packet to the water installation controlling apparatus.

The provision of the step relating to providing the requested time taking into account if the update is critical or not allows improving the software updates because it is the updating system which performs the scheduling of the software updates and not the water installation controlling apparatus which may not know the load of updates of the updating system. Therefore, the software updates may be rationally scheduled by the updating system avoiding excessive slowness in the software updates (the updating system may thus not be overloaded with a large number of updates).

On the other hand, the water installation controlling apparatus may provide to the updating system a reference of the software packets to be updated. This way, the updating system may know the software packets to be updated and if the update may be critical or not.

In some examples, the method may comprise receiving a request from the water installation controlling apparatus of the data comprising at least a reference of the last version of the one or more software packets. Basically, the data may be automatically send by the updating system to the water installation controlling apparatus (for example at any given time) or may be automatically requested by the water installation controlling apparatus to the updating system (for example at any given time).

According to another aspect, a computer program product is disclosed. The computer program product may comprise program instructions for causing a computing system to perform a method of providing updates of one or more software packets to a water installation controlling apparatus according to some examples disclosed herein. Said computing system may be a part of the updating system (i.e. a computing system inside the updating system configured to reproduce the method described above) of may be the updating system itself.

In yet another aspect, a system for providing updates of one or more software packets to a water installation controlling apparatus is disclosed. The system may comprise computing/electronic means for providing data comprising at least a reference of a last version of the one or more software packets to the water installation controlling apparatus; computing/electronic means for receiving a request from the water installation controlling apparatus relating to the time when the update of the software packets to be updated must be performed; computing/electronic means for providing the requested time taking into account if the update is critical or not; computing/electronic means for receiving a request for downloading the last version of the software packet from the water installation controlling apparatus.

Basically, this system must be able to reproduce the method described above by means of electronic/computing means. Said electronic/computing means may be used interchangeably, that is, a part of the described means may be electronic means and the other part may be computer means, or all described means may be electronic means or all described means may be computer means. Examples of a system comprising only electronic means may be a CPLD, an FPGA or an ASIC.

It is important to highlight that said system may be a part of the updating system (i.e. a system inside the updating system configured to reproduce the method described above) of may be the updating system itself.

On the other hand, the information exchange between said system and the water installation controlling apparatus (or a system or a computing system comprised in the water installation controlling apparatus) may be performed through a communication network, for example a global communication network such as the Internet. Said communication may be secured by means of, for example, cryptographic keys and/or an SSL tunnel established between them.

According to another aspect, a computing system is disclosed. The computing system may comprise a memory and a processor, embodying instructions stored in the memory and executable by the processor, the instructions comprising functionality to execute a method of providing updates of one or more software packets to a water installation controlling apparatus according to some examples disclosed herein.

Therefore, said computing system must be able to reproduce the method described above by means of instructions executed by the processor. Furthermore, said computing system may be a part of the updating system (i.e. a computing system inside the updating system configured to reproduce the method described above) of may be the updating system itself.

The information exchange between said computing system and the water installation controlling apparatus (or a system or a computing system comprised in the water installation controlling apparatus) may be performed through a communication network, for example a global communication network such as the Internet. Said communication may be secured by means of, for example, cryptographic keys and/or a SSL tunnel established between them.

Additional objects, advantages and features of embodiments of the invention will become apparent to those skilled in the art upon examination of the description, or may be learned by practice of the invention.

### BRIEF DESCRIPTION OF THE DRAWINGS

Non-limiting examples of the present disclosure will be described in the following, with reference to the appended drawings, in which:

FIG. 1 illustrates a block diagram of a water installation controlling apparatus according to some examples;

FIG. 2 illustrates a block diagram of a water installation system according to some examples;

FIG. 3 is a flow diagram of a method of updating one or more software packets in a water installation controlling apparatus according to some examples;

FIG. 4 illustrates the content of an XML file according to some examples;

FIG. 5 is a flow diagram of a method of providing updates of one or more software packets to a water installation controlling apparatus according to some examples;

FIG. 6 is a flow diagram of a method of operating at least one water installation device connected to a water installation controlling apparatus according to some examples.

### DETAILED DESCRIPTION

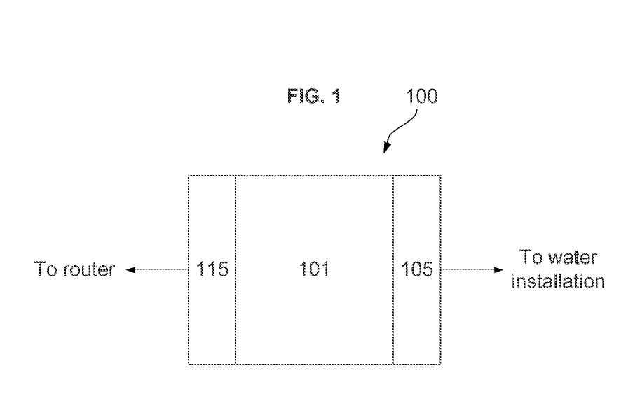

FIG. 1 illustrates a block diagram of a water installation controlling apparatus according to some examples. Basically, a water installation controlling apparatus 100 comprises a processing module 101, an interface module 105 for connecting the apparatus to at least one water installation device, and a network access module 110 for accessing the apparatus to a communication network, for example a global communication network such as the Internet.

The processing module 101 may be implemented by computing means, electronic means or a combination of them. The computing means may be a set of instructions (that is, a computer program) and then the processing module may comprise a memory and a processor, embodying said set of instructions stored in the memory and executable by the processor, the instructions comprising functionality to execute at least a method of updating one or more software packets in a water installation controlling apparatus as will disclosed below. In case the processing module 101 is implemented only by electronic means, the processing module may be, for example, a CPLD, an FPGA or an ASIC. In case the processing module 101 is a combination of electronic and computing means, the computing means may be a set of instructions and the electronic means may be any electronic circuit capable of implementing the corresponding step or steps of the cited method.

It is important to highlight that said processing module 101 may be implemented in the water installation controlling apparatus 100 by a system (or by a computing system) comprised in it or connected to it, and configured to specifically perform this method, or may be the water installation controlling apparatus itself as a whole, that is, the same resources (e.g. memory, processor, electronic circuits, etc.) of the water installation controlling apparatus may be configured to perform different tasks (for example, among other tasks, the execution of the cited method).

The interface module 105 may be connectable to one or more water installation devices such as water pumps, water temperature controllers, thermostats, lighting installations or the like. The interface module may be configured to be physically connected to the water installation devices via a cable or it may be wirelessly connected to a wireless module of the water installation devices. Thus, this interface module may comprise a wired/wireless communication interface, for example, it may be any standard interface such as Bluetooth, Wi-Fi or Ethernet but it is not limited to them.

On the other hand, the network access module 110 may be configured to be connected to a network access point such as a router. The router may be available in the vicinity of the water installation, e.g. in a building housing or being next to the water installation, and may be connected to the communication network such as the Internet. This way, the water installation controlling apparatus 100 may access to the Internet through the network access module 110 connected to the router.

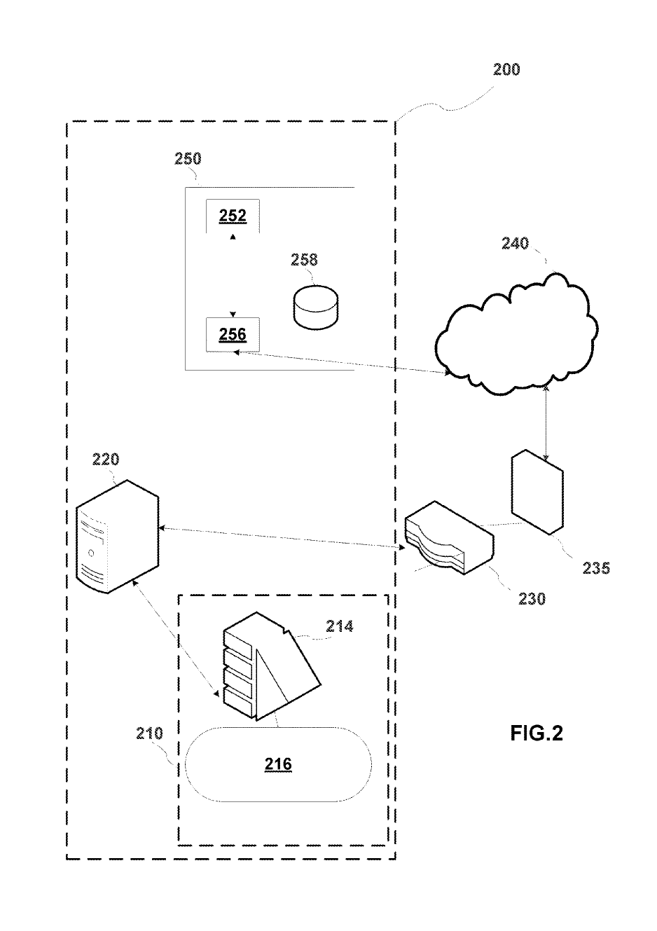

FIG. 2 illustrates a block diagram of a water installation system 200 according to some examples. Water installation system 200 comprises a water installation configuration 210, a water installation controlling apparatus 220 and an updating system 250. The water installation configuration may comprise a water installation 216 and one or more water installation devices 214. The water installation devices 214 may form part of the water installation 216 or they may be installed with or by the water installation 216. Alternatively, they may be connected to the water installation 216 to control or measure a property of the water installation 216 or of its environment.

The water installation controlling apparatus 220 and the updating system 250 may be connected between them through a communication network 240 such as the Internet. A router 230 may provide access to the communication network 240 for the water installation controlling apparatus 220. The router may be protected by a firewall 235 or not. For that purpose, the updating system 250 may also be connected to the communication network 240 such as the Internet.

The established communication between the updating system 250 and the water installation controlling apparatus 220 may be a secured communication (or a non-secured communication). Said securitization of the communication may be obtained, for example, by means of cryptographic keys (the updating system 250 may comprise its public and private keys and the public key of the water installation controlling apparatus 220 whereas the water installation controlling apparatus may comprise its public and private keys and the public key of the updating system 250) or by means of a SSL tunnel (not shown in FIG. 2) established between the updating system 250 and the water installation controlling apparatus. Consequently, the water installation controlling apparatus and the updating system 250 may be configured to exchange information (data, updates, etc.) between them through the communication network 240, as can be seen in FIG. 2.

Therefore, the proposed solution in FIG. 2 establishes a secure communications gateway via the communication network 240, such as the Internet, to enable bi-directional connections between the updating system 250 and the water installation controlling apparatus 220. As described above, bi-directional communications may be established in a secured and encrypted form so that the information, the updating system 250 and the water installation controlling apparatus 220 are safe from unauthorized access. The communications may be dynamically set regardless of whether the IP addresses of the devices are static or dynamic.

The water installation to which at least one device is associated may be a simple water container. Various independent water installation devices may be used to control aspects of the water installation such as water temperature, lighting, water quantity, water quality etc. The water installation controlling apparatus may then be configured to be connected to one or more of such water installation devices.

Concerning the updating system 250, it may basically comprise a processing module 252, a network access module 256 for accessing the updating system to the communication network 240, and a repository of data 258 for storing at least the different versions of software packets that may be required by the water installation controlling apparatus 100.

The processing module 252 of the updating system 250 may be implemented by computing means, electronic means or a combination of them. The computing means may be a set of instructions and the processing module 252 may comprise a memory and a processor, embodying said set of instructions stored in the memory and executable by the processor, the instructions comprising functionality to execute a method of providing updates of one or more software packets to a water installation controlling apparatus 220 as will disclosed below. In case the processing module 252 is implemented only by electronic means, said processing module may be, for example, a CPLD, an FPGA or an ASIC. In case the processing module 252 is a combination of electronic and computing means, the computing means may be a set of instructions and the electronic means may be any electronic circuit capable of implementing the corresponding step or steps of the cited method.

It is important to highlight that said processing module 252 may be implemented in the updating system 250 by a system (or by a computing system) comprised in it or connected to it, and configured to specifically perform the cited method, or may be the updating system itself as a whole, that is, the same resources (e.g. memory, processor, electronic circuits, etc.) of the updating system may be configured to perform different tasks (for example, among other tasks, the execution of the cited method).

On the other hand, by means of the network access module 256 the updating system 250 may connect, through the cited communication network 240, to the water installation controlling apparatus 220 for exchanging information (data, updates, . . . ) between them. For that purpose and others, the network access module 256 may be configured to be connected to a network access point such as a router (not shown). The router may be available in the vicinity of the updating system and may be connected to the communication network 240. As described above, the established communication between the updating system and the water installation controlling apparatus may be a secure communication. Consequently, the updating system and the water installation controlling apparatus may be configured to exchange information (data, updates, etc.) with the water installation controlling apparatus through the secured communication.

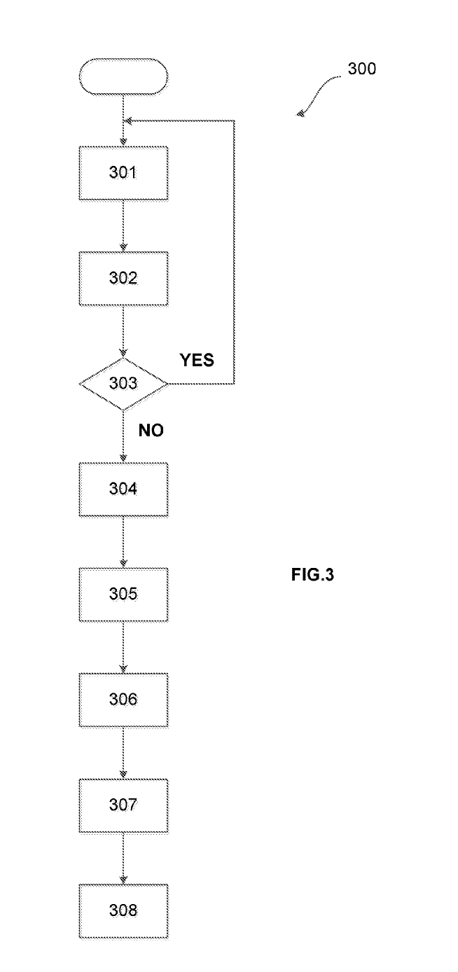

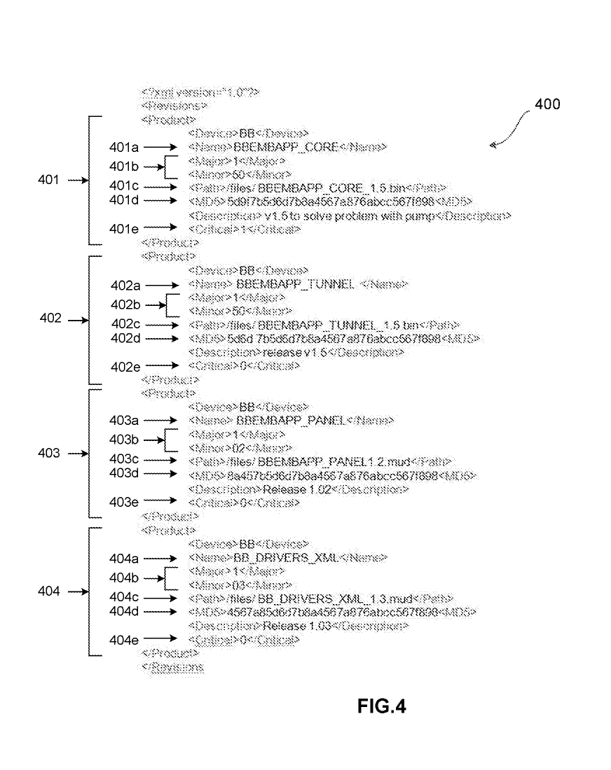

Following, based on the disclosed water installation system 200 and FIGS. 3 and 4, a method 300 for updating one or more software packets in a water installation controlling apparatus will be disclosed.

In a first step 301, the water installation controlling apparatus 220 obtains from the updating system 250 data comprising at least a reference of a last version of the one or more software packets through the communication network 240. Basically, the data may be automatically sent by the updating system 250 to the water installation controlling apparatus 220 (for example at any given time such as at 3 in the morning) or may be automatically requested by the water installation controlling apparatus 220 to the updating system 250 (for example at any given time). In any case, the involvement of a user is not required.

Said data obtained from the updating system 250 may be comprised in a file, such as an eXtensible Markup Language (XML) file 400. An example of this type of files is illustrated in FIG. 4. As can be seen in this figure, the file may comprise different pieces of code 401,402,403,404 for each available last version of software packet, each piece of code comprising a plurality of instructions (other instructions may also be comprised) such as:
the name 401a,402a,403a,404a of the software packet;
A reference 401b,402b,403b,404b relating to the last version of the software packet;
A link 401c,402c,403c,404c pointing to where the software packet is stored;
An electronic fingerprint 401d,402d,403d,404d of the software packet;
A reference 401e,402e,403e,404e indicating if the update of the software packet is critical or not.

At this point it is important to highlight that each piece of code in the same XML file may comprise different instructions. This way, a piece of code may comprise only the name of the software packet and the reference of the last version of the software packet and another piece of code may comprise these instructions and further the link through which the software packet may be downloaded and/or the reference indicating if the updating of the software packet is critical or not.

The cited electronic fingerprint of the software packet may be a hash, which may be obtained by applying a cryptographic hash function to the software packet in the updating system 250.

of the software packet with the reference of the current version of the corresponding software packet used in the water installation controlling apparatus 220. Said reference relating to the current version of the software packet may be stored in a memory (e.g. in a hard disk) of the water installation controlling apparatus.

Next, in step 303, for each software packet, if the obtained reference of the last version of the software packet does not coincide with the reference of the current version of the corresponding software packet, the apparatus 220 selects, in step 304, the corresponding software packet to be updated. This way, in case at least one corresponding software packet is to be updated, the water installation controlling apparatus 220 requests, in step 305, the updating system 250 to provide a time of when the update must be performed and later receives, in step 306, from the updating system 250 said requested time taking into account if the update is critical or not. Thus, the updating system 250 clearly will be in charge of schedule the update/s. Furthermore, the updating system knows when an update is critical or not and includes this condition in the XML file for each software packet.

It is important to highlight that, in step 305, the system may request the updating system 250 to provide a time for each software packet to be updated of when the update must be performed or the system may request the updating system 250 to provide a time for all software packets to be updated of when the update must be performed. Consequently, in step 306, the system may receive a time for each software packet to be updated or only a time for updating all software packets at once (sequentially o in parallel).

On the contrary, for all software packets, if the obtained reference of the last version of the software packet coincides with the reference of the current version of the corresponding software packet, an update of some software packet is not required and the apparatus 220 will wait until the following programmed or forced update process.

On the other hand, the time when the update of each software packet to be updated must be performed may be communicated to a user, for example, by email. This way, the apparatus 220 will not ask for permission to the user to update any software packet but the system will inform the user that an update will take place and it will also warn about the time in which the update will be performed, except for critical updates. In case of critical updates, the apparatus 220 may inform the user after the update is performed. According to other examples, it is possible for the user to agree with the update conditions.

Next, for each software packet to be updated at the time for performing the update, the apparatus downloads, in step 307, the last version of the software packet from the updating system 250 taking into account the link (this link may be secured by means of a user/password or by means an encryption) comprised in the XML file and replaces, in step 308, the current version of the software packet used in the water installation controlling apparatus 220 by the downloaded last version of the software packet. More specifically, in step 308, the apparatus 250 replaces the software of the current version of the software packet used in the water installation controlling apparatus 220 by the software comprised in the downloaded last version of the software packet.

Based on the electronic fingerprint (e.g. a hash) comprised in the XML file for each software packet, the water installation controlling apparatus 220 may validate if the downloaded last version of the software packet corresponds to the last version of the software packet stored in the updating system 250. For doing this, the water installation controlling apparatus 220 may, firstly, obtain the electronic fingerprint (i.e. the hash) of the last version of the software packet from the obtained XML file. Next, the apparatus 220 may generate a hash of the downloaded last version of the software packet by applying a cryptographic hash function to it and compare the obtained hash of the last version of the software packet and the generated hash of the downloaded last version of the software packet. This way, if the obtained hash of the last version of the software packet does not coincide with the generated hash of the downloaded last version of the software packet, the apparatus may download again the last version of the software packet from the updating system 250. Obviously, said new downloaded last version of the software packet may be validated again.

On the contrary, if the obtained hash of the last version of the software packet coincides with the generated hash of the downloaded last version of the software packet, it means the last version of the software packet has been correctly downloaded from the updating system, that is, the downloaded last version of the software packet corresponds fully to the last version of the software packet stored in the updating system.

Moreover, it is possible to communicate to the user (or to another user) the completion of the replacement of the current version of the software packet used in the water installation controlling apparatus 220 by the downloaded last version of the software packet. Furthermore, another events may be communicated to the user.

On the other hand, it is possible that the system stores in a repository (for example, a database) data relating to the completion of the replacement of the current version of the software packet used in the water installation controlling apparatus 220 by the downloaded last version of the software packet. Obviously, other data (e.g. errors produced in the apparatus, time when the update of each software packet to be updated is performed, etc.) may be stored in said repository of in another repository. The repository may be in the updating system 250 (for example the repository 258 shown in FIG. 2), in the water installation controlling apparatus 220 or in another apparatus connected to the updating system 250 or to the water installation controlling apparatus 220 through a communication network such as the Internet.

In case an error is detected during replacing the current version of the software packet used in the water installation controlling apparatus by the downloaded last version of the software packet, the method may further comprise replacing the downloaded last version of the software packet by the previous version of the software packet used in the water installation controlling apparatus. Consequently, the water installation controlling apparatus 220 automatically returns to the last operational configuration and if this is not possible it may return to the factory settings (in this case a user pressing the reset button of the water installation apparatus 220 may be required).

As described above, the water installation controlling apparatus 220 may be configured to operate a plurality of water installation device types through software associated to each water installation device type. The one or more software packets may comprise a first software packet comprising the software associated to each water installation device type that may be operated by the water installation controlling apparatus 220.

Consequently, said first software packet may also comprise the software associated to each water installation device type that may be operated by the water installation controlling apparatus 220 and not only the software associated to the water installation devices 214 connected to the water installation controlling apparatus.

A modification in a software associated to a supported water installation device type or the inclusion of a software associated to a new water installation device type until then not supported may require to generate a new version of said first software packet and consequently an update of said first software packet is required.

The term “software associated to a water installation device type” may be understood as a descriptor file associated to a water installation device type. Thus, in the context of the present disclosure, a descriptor file for a water installation device may be defined as a piece of software based on a code (i.e. instructions) written under a textual data format, i.e. a human-readable and machine readable format. This piece of software may be seen as a descriptor of (i.e. as describing) how the device has to be operated by a (water installation) controlling apparatus and configured by a user (of the water installation). The water installation controlling apparatus may have a processor configured to execute general purpose software and to process the descriptor file in such a way that the device is operated (by the controlling apparatus) and configured (by a user) in the context of said software of more general purpose. This software of more general purpose may comprise e.g. calls to an interpreter dedicated to interpret and execute the content of the descriptor file. This way, the execution of the general purpose software can cause operation of the device when required by performing necessary functions that are implemented in the descriptor file in a manner which is exclusive for the device. This “exclusive” implementation may depend on e.g. the hardware configuration of the device and other particularities.

On the other hand, the one or more software packets may comprise a second software packet comprising software associated to the water installation controlling apparatus 220, said software associated to the water installation controlling apparatus being configured for operating at least one water installation device 214 connected to the water installation controlling apparatus, said at least one water installation device belonging to the supported water installation device types.

Basically, the second software packet may comprises software comprising at least one computer program running on the operating system of the water installation controlling apparatus 220. Said computer program is capable of operating the water installation devices connected to the water installation controlling apparatus by means of the software associated to each water installation device (that is, the software comprised in the first software packet) for controlling different parameters (e.g. the temperature, the quality, or the quantity of water) of a water installation (e.g. swimming pools, artificial spas, fish farms or the like).

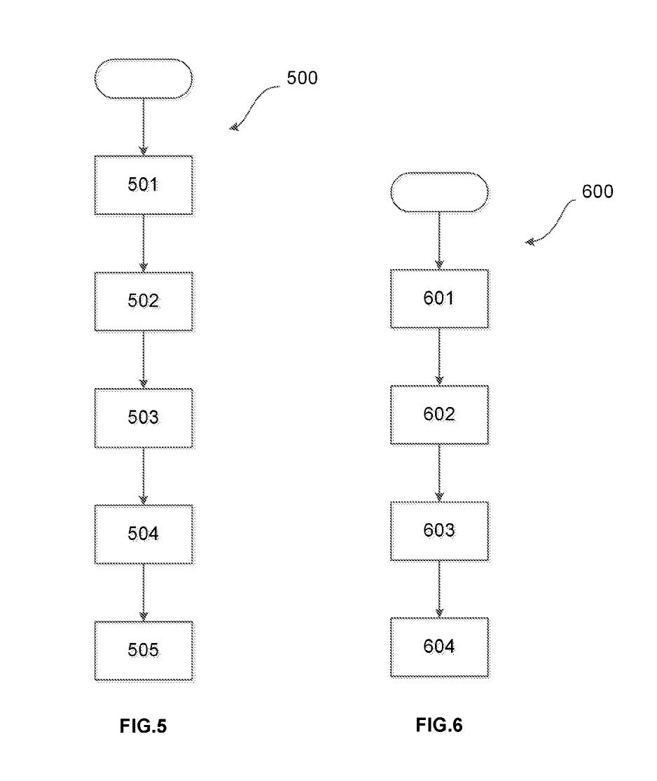

In FIG. 5 a flow diagram of a method 500 of providing updates of one or more software packets to a water installation apparatus 220 is shown. This method is executed by the updating system 250 (or in a system comprised or connected to said updating system) and it is complementary to the method of updating one or more software packets in a water installation controlling apparatus disclosed above, said updating method being executed in the water installation controlling apparatus 220.

The method 500 of providing updates of one or more software packet to a water installation apparatus may comprise, in a first step 501, providing data comprising at least a reference of the last version of the one or more software packets to the water installation controlling apparatus. As described above, said data may be comprised in a file, for example a XML file. Consequently, the updating system 250 may provide this XML file to the water installation controlling apparatus 220.

Next, in step 502, the updating system 250 may receive a request from the water installation controlling apparatus 220 relating to the time when the update of each software packet to be updated of the one or more software packets must be performed, because the updating system 250 is in charge of schedule the update.

Following, in step 503, the updating system 250 may provide to the water installation controlling apparatus 220 the requested time for each software packet to be updated taking into account if the update is critical or not. Then, in step 504, for each software packet to be updated at the time for performing the update, the updating system 250 may receive from the water installation controlling apparatus a request for downloading the last version of the software packet and, from said request, the updating system may transmit, in step 505, the last version of the software packet to the water installation controlling apparatus.

As also described above, the updating system 250 may receive a request from the water installation controlling apparatus 220 of the data comprising at least a reference of the last version of the one or more software packets (that is, a request of the XML file according to some examples).

In some examples, the water installation controlling apparatus 220 is also capable of executing a method 600 of operating at least one water installation device 214 connected to it, as can be seen in FIG. 6.

Basically, the method 600 may comprise a first step 601 of obtaining from the water installation device 214 at least a manufacturer ID and a firmware version of the water installation device (the product ID may be also obtained). This way, the water installation controlling apparatus 220 is capable of identifying the water installation device type to which the device 214 connected to it belongs.

Next, the method may comprise the step 602 of using the corresponding software associated to the water installation device type for operating the water installation device, said corresponding software being selected taking into account the obtained manufacturer ID and the firmware version (and the product ID if it is previously used) of the water installation device.

At any time, a step 603 of executing a method of updating one or more software packets in the water installation controlling apparatus as described above is performed. This way, the software associated to the water installation device 214 is always available in its last version.

Finally, the method may comprise detecting, in step 604, a new water installation device connected to the water installation controlling apparatus. That is, when a new water installation device is connected to the water installation controlling apparatus 220 and a scan of devices is performed (for example, a scan requested by a user), the water installation controlling apparatus is capable of detecting this new device and, because the first software packet comprises the software associated to each water installation device type that can be operated by the water installation controlling apparatus and not only the software associated to the water installation devices connected to said water installation controlling apparatus (consequently, after an update of the first software packet, the water installation controlling apparatus has available the software associated to all water installation device types supported by the apparatus), the water installation controlling apparatus immediately can operate the new device using the software associated to the water installation device to which the new device belongs.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

Further, although the examples described with reference to the drawings comprise computing apparatus/systems and processes performed in computing apparatus/systems, the invention also extends to computer programs, particularly computer programs on or in a carrier, adapted for putting the system into practice.

The present disclosure also includes the various combination of elements as provided in the clauses below.

Clause 1. A method of updating one or more software packets in a water installation controlling apparatus, the method comprising:
obtaining from an updating system data comprising at least a reference of a last version of the one or more software packets;
for each software packet, comparing the obtained reference of the last version of the software packet with a reference of a current version of a corresponding software packet used in the water installation controlling apparatus;
for each software packet, if the obtained reference of the last version of the software packet does not coincide with the reference of the current version of the corresponding software packet, then selecting the corresponding software packet to be updated;

in case at least one corresponding software packet is to be updated,
requesting the updating system to provide a time of when the update must be performed;
receiving from the updating system the requested time taking into account if the update is critical or not;

for each software packet to be updated at the time for performing the update,
downloading the last version of the software packet from the updating system;
replacing the current version of the software packet used in the water installation controlling apparatus by the downloaded last version of the software packet.

Clause 2. The method according to clause 1, further comprising:
requesting the updating system to provide data comprising at least a reference of the last version of the one or more software packets.

Clause 3. The method according to any of clauses 1 or 2, in case at least one corresponding software packet is to be updated, further comprising:
requesting a user to provide an authorization for performing the update.

Clause 4. The method according to any of clauses 1 to 3, further comprising:
communicating to a user the time when the update of each software packet to be updated must be performed.

Clause 5. The method according to any of clauses 1 to 4, further comprising:
validating the downloaded last version of the software packet.

Clause 6. The method according to clause 5, wherein the obtained data comprising at least a reference of the last version of the one or more software packets further comprises an electronic fingerprint associated to each software packet of the one or more software packets and wherein:
validating the downloaded last version of the software packet comprises:
   obtaining an electronic fingerprint of the last version of the software packet from the obtained data;
   generating an electronic fingerprint of the downloaded last version of the software packet;
   comparing the obtained electronic fingerprint of the last version of the software packet and the generated electronic fingerprint of the downloaded last version of the software packet;
   If the obtained electronic fingerprint of the last version of the software packet does not coincide with the generated electronic fingerprint of the downloaded last version of the software packet:
      downloading again the last version of the software packet from the updating system.

Clause 7. The method according to clause 6, wherein the electronic fingerprint comprises a cryptographic hash value.

Clause 8. The method according to any of clauses 1 to 7, wherein the obtained data comprising at least a reference of the last version of the one or more software packets further comprises a link to the last version of each software packet of the one or more software packets and wherein:
downloading the last version of the software packet from the updating system comprises:
   obtaining the link to the last version of the software packet from the obtained data;
   initiating a transfer, based on the obtained link, of the last version of the software packet from the updating system;
   receiving the last version of the software packet from the updating system.

Clause 9. The method according to any of clauses 1 to 8, wherein the obtained data comprising at least a reference of the last version of the one or more software packets further comprises a parameter indicating if the update of each software packet of the one or more software packets is critical or not.

Clause 10. The method according to any of clauses 1 to 9, further comprising:
communicating to a user a completion of the replacement of the current version of the software packet used in the water installation controlling apparatus by the downloaded last version of the software packet.

Clause 11. The method according to clause 10, further comprising:
storing in a repository data relating to the completion of the replacement of the current version of the software packet used in the water installation controlling apparatus by the downloaded last version of the software packet.

Clause 12. The method according to any of clauses 1 to 11, wherein the data comprising at least a reference of the last version of the one or more software packets is comprised in a file.

Clause 13. The method according to clause 12, wherein the file comprising the data comprising at least a reference of the last version of the one or more software packets is an eXtensible Markup Language (XML) file.

Clause 14. The method according to any of clauses 1 to 13, wherein:
in case an error is detected during replacing the current version of the software packet used in the water installation controlling apparatus by the downloaded last version of the software packet, the method further comprises:
   replacing the downloaded last version of the software packet by the previous version of the software packet used in the water installation controlling apparatus.

Clause 15. The method according to any of clauses 1 to 14, wherein the water installation controlling apparatus is configured to operate a plurality of water installation device types through software associated to each water installation device type.

Clause 16. The method according to clause 15, wherein a first software packet of the one or more software packets comprises the software associated to each water installation device type that can be operated by the water installation controlling apparatus.

Clause 17. The method according to any of clauses 15 or 16, wherein a second software packet of the one or more software packets comprises software associated to the water installation controlling apparatus, said software associated to the water installation controlling apparatus being configured for operating at least one water installation device connected to the water installation controlling apparatus, said at least one water installation device belonging to the supported water installation device types.

Clause 18. A computer program product comprising program instructions for causing a computing system to perform a method according to any of clauses 1 to 17 of updating one or more software packets in a water installation controlling apparatus.

Clause 19. A computer program product according to clause 18, embodied on a storage medium.

Clause 20. A computer program product according to clause 18, carried on a carrier signal.

Clause 21. A system for updating one or more software packets in a water installation controlling apparatus, the system comprising:
computing/electronic means for obtaining from an updating system data comprising at least a reference of a last version of the one or more software packets;
computing/electronic means for comparing the obtained reference of the last version of each software packet with a reference of a current version of a corresponding software packet used in the water installation controlling apparatus;
computing/electronic means for selecting the corresponding software packet to be updated;
computing/electronic means for requesting the updating system to provide a time of when the update must be performed;
computing/electronic means for receiving from the updating system the requested time taking into account if the update is critical or not;
computing/electronic means for downloading the last version of the software packet from the updating system;
computing/electronic means for replacing the current version of the software packet used in the water installation controlling apparatus by the downloaded last version of the software packet.

Clause 22. A computing system comprising a memory and a processor, embodying instructions stored in the memory and executable by the processor, the instructions comprising functionality to execute a method according to any of clauses 1 to 17 of updating one or more software packets in a water installation controlling apparatus.

Clause 23. A method of operating at least one water installation device connected to a water installation controlling apparatus, said water installation controlling apparatus being configured to operate a plurality of water installation device types by means of a software associated to each water installation device type, said at least one water installation device belonging to the plurality of water installation device types, the method comprising:
obtaining from the water installation device at least a manufacturer ID and a firmware version of the water installation device;
executing a method according to any of clauses 1 to 17 of updating one or more software packets in the water installation controlling apparatus;
using the corresponding software associated to the water installation device type for operating the water installation device, said corresponding software being selected taking into account the obtained manufacturer ID and the firmware version.

Clause 24. The method according to clause 23, further comprising:
obtaining from the water installation device at least the manufacturer ID, the firmware version and a product ID of the water installation device;
using the corresponding software associated to the water installation device type for operating the water installation device, said corresponding software being selected taking into account the obtained manufacturer ID, the firmware version and the product ID of the water installation device.

Clause 25. The method according to any of clauses 23 or 24, further comprising:
detecting a new water installation device connected to the water installation controlling apparatus.

Clause 26. A computer program product comprising program instructions for causing a computing system to perform a method according to any of clauses 23 to 25 of operating at least one water installation device connected to a water installation controlling apparatus.

Clause 27. A system for operating at least one water installation device connected to a water installation controlling apparatus, said water installation controlling apparatus being configured to operate a plurality of water installation device types by means of a software associated to each water installation device type, said at least one water installation device belonging to the plurality of water installation device types, the system comprising:
computing/electronic means for obtaining from the water installation device at least a manufacturer ID and a firmware version of the water installation device;
a system according to clause 21 for updating one or more software packets in a water installation controlling apparatus;
computing/electronic means for using the corresponding software associated to the water installation device for operating the water installation device, said corresponding software being selected taking into account the obtained manufacturer ID and the firmware version.

Clause 28. A computing system comprising a memory and a processor, embodying instructions stored in the memory and executable by the processor, the instructions comprising functionality to execute a method according to any of clauses 23 to 25 of operating at least one water installation device connected to a water installation controlling apparatus.

Clause 29. A method of providing updates of one or more software packets to a water installation controlling apparatus, the method comprising:
providing data comprising at least a reference of a last version of the one or more software packets to a water installation controlling apparatus;
receiving a request from the water installation controlling apparatus relating to a time of when the update must be performed;
providing the requested time taking into account if the update is critical or not;

for each software packet to be updated at the time for performing the update,
receiving from the water installation controlling apparatus a request for downloading the last version of the software packet;
transmitting the last version of the software packet to the water installation controlling apparatus.

Clause 30. The method according to clause 29, further comprising:
receiving a request from the water installation controlling apparatus of the data comprising at least a reference of the last version of the one or more software packets.

Clause 31. A computer program product comprising program instructions for causing a computing system to perform a method according to any of clauses 29 or 30 of providing updates of one or more software packets to a water installation controlling apparatus.

Clause 32. A system for providing updates of one or more software packets to a water installation controlling apparatus, the system comprising:
computing/electronic means for providing data comprising at least a reference of a last version of the one or more software packets to the water installation controlling apparatus;
computing/electronic means for receiving a request from the water installation controlling apparatus relating to a time of when the update must be performed;
computing/electronic means for providing the requested time taking into account if the update is critical or not;
computing/electronic means for receiving a request for downloading the last version of the software packet from the water installation controlling apparatus.

Clause 33. A computing system comprising a memory and a processor, embodying instructions stored in the memory and executable by the processor, the instructions comprising functionality to execute a method according to any of clauses 29 or 30 of providing updates of one or more software packets to a water installation controlling apparatus.

What is claimed is:

1. A method of updating a first software packet in a water installation controlling apparatus, the first software packet being associated with a plurality of water installation device types, the method comprising:
the water installation controlling apparatus obtaining from an updating system data comprising at least a reference of a last version of the first software packet;
the water installation controlling apparatus comparing the obtained reference of the last version of the first software packet with a reference of a current version of a corresponding first software packet used in the water installation controlling apparatus;
if the obtained reference of the last version of the first software packet does not coincide with the reference of the current version of the corresponding first software packet, then selecting the corresponding first software packet to be updated; and
downloading the last version of the first software packet from the updating system.

2. The method according to claim 1, further comprising replacing the current version of the first software packet used in the water installation controlling apparatus by the downloaded last version of the software packet.

3. The method according to claim 1, further comprising the water installation controlling apparatus requesting the updating system to provide data comprising at least a reference of the last version of the first software packet.

4. The method according to claim 1, wherein the water installation controlling apparatus is operably connected to one or more water installation devices, the one or more water installation devices belonging to the plurality of water installation device types, the water installation controlling apparatus operating the one or more water installation devices through software that runs on the water installation controlling apparatus, the software comprising the last version of the first software packet, the last version of the first software packet being associated to each water installation device type to which the water installation controlling apparatus is operably connected.

5. The method according to claim 1, wherein the water installation controlling apparatus is capable of operating first and second sets of water installation device types, the water installation controlling apparatus being operably coupled to one or more water installation devices belonging to the first set of water installation device type and not operably coupled to water installation devices belonging to the second set of water installation device type, the water installation controlling apparatus operating the one or more water installation devices through a software that comprises the last version of the first software packet and that runs on the water installation controlling apparatus, the last version of the first software packet being associated to both the first and second sets of water installation device types.

6. The method according to claim 5, further comprising the water installation controlling apparatus detecting a new water installation device connected to the water installation controlling apparatus.

7. The method according to claim 6, wherein the water installation controlling apparatus operates the new water installation device by use of the last version of the first software packet.

8. The method according to claim 5, further comprising the water installation controlling apparatus detecting a new water installation device connected to the water installation controlling apparatus, the new water installation device belonging to the second water installation device type.

9. The method according to claim 8, wherein the water installation controlling apparatus operates the new water installation device by use of the last version of the first software packet.

10. The method according to claim 4, wherein a second software packet is associated with the water installation controlling apparatus, the method further comprising:
the water installation controlling apparatus obtaining from the updating system data comprising at least a reference of a last version of the second software packet;
the water installation controlling apparatus comparing the obtained reference of the last version of the second software packet with a reference of a current version of a corresponding second software packet used in the water installation controlling apparatus;
if the obtained reference of the last version of the second software packet does not coincide with the reference of the current version of the corresponding first software packet, then selecting the corresponding second software packet to be updated;
the water installation controlling apparatus requesting the updating system to provide a time of when the update is to be performed;
downloading the last version of the second software packet from the updating system.

11. The method according to claim 10, wherein the second software packet is a computer program that runs on an operating system of the water installation controlling apparatus, the computer program operating the plurality of water installation device types operably connected to the water installation controlling apparatus by means of the last version of the first software packet.

12. The method according to claim 5, wherein a second software packet is associated with the water installation controlling apparatus, the method further comprising:
the water installation controlling apparatus obtaining from the updating system data comprising at least a reference of a last version of the second software packet;
the water installation controlling apparatus comparing the obtained reference of the last version of the second software packet with a reference of a current version of a corresponding second software packet used in the water installation controlling apparatus;
if the obtained reference of the last version of the second software packet does not coincide with the reference of the current version of the corresponding first software packet, then selecting the corresponding second software packet to be updated;
the water installation controlling apparatus requesting the updating system to provide a time of when the update is to be performed;
downloading the last version of the second software packet from the updating system.

13. The method according to claim 12, wherein the last version of the second software packet is a computer program that runs on an operating system of the water installation controlling apparatus, the computer program operating the plurality of water installation device types operably connected to the water installation controlling apparatus by means of the last version of the first software packet.

14. The method according to claim 1, wherein the obtained data comprises at least a reference of the last version of the first software packets and a parameter indicating if the update is critical or not.

15. The method according to claim 1, further comprising the water installation controlling apparatus requesting the updating system to provide a time of when the update is to be performed and at a designated time set by the updating system downloading the last version of the first software packet from the updating system.

16. A method of operating at least one water installation device connected to a water installation controlling apparatus, said water installation controlling apparatus being configured to operate a plurality of water installation device types by means of a software associated to each water installation device type, said at least one water installation device belonging to the plurality of water installation device types, the method comprising:
the water installation controlling apparatus obtaining from the water installation device at least a manufacturer ID and/or firmware version of the water installation device;
downloading in the water installation controlling apparatus a software packet associated to the water installation device from an updating system, the software packet being selected by the water installation controlling apparatus taking into account the obtained manufacturer ID and the firmware version.

17. The method according to claim 16, further comprising obtaining from the water installation device a product ID of the water installation device;
downloading in the water installation controlling apparatus a software packet associated to the water installation device from an updating system, the software packet being selected by the water installation controlling apparatus taking into account the obtained product ID.

18. The method according to claim 16, further comprising the water installation controlling apparatus detecting a new water installation device connected to the water installation controlling apparatus.

19. The method according to claim 18, wherein the water installation controlling apparatus operates the new water installation device by use of the software packet.
